(19) United States
(12) Patent Application Publication
(10) Pub. No.: US 2023/0081804 A1
(43) Pub. Date: Mar. 16, 2023

(54) DISPLAY DEVICE AND THIN FILM TRANSISTOR ARRAY SUBSTRATE

(71) Applicant: Century Technology (Shenzhen) Corporation Limited, Shenzhen (CN)

(72) Inventors: DENG-KAI CHANG, New Taipei (TW); CHING-TUNG WANG, Hsinchu (TW); YI-HUNG TSAI, New Taipei (TW); CHIEN-CHANG WANG, New Taipei (TW); AN-CHOU CHEN, New Taipei (TW)

(21) Appl. No.: 17/678,747

(22) Filed: Feb. 23, 2022

(30) Foreign Application Priority Data
Sep. 9, 2021 (CN) 202111055486.5
Nov. 9, 2021 (CN) 202111318870.X

(51) Int. Cl. G02F 1/1362

(52) U.S. Cl. CPC G02F 1/136286; G02F 1/136222

(57) ABSTRACT

A display device defines a display area and a non-display area and includes a thin film transistor array substrate, a circuit board, and a light modulating layer. The thin film transistor array substrate includes a glass substrate, a driving circuit, and at least one conductive part. The opposing first and second surfaces of the glass substrate define at least one through hole penetrating both, the through hole accommodating one conductive part which extends to electrically connect the driving circuits on the first and second surfaces. The circuit board is electrically connected to the driving circuit on the first surface. The light modulating layer is in the display area and is on the second surface. The light modulating layer is electrically connected to the driving circuit on the second surface.

### FIELD

The present disclosure generally relates to display technology, particularly relates to a display device and a thin film transistor array substrate applied in the display device.

### BACKGROUND

A display device includes an array substrate, a light-modulating component, a circuit board, and a driving chip. A surface of the array substrate defines a display area and a non-display area. The light-modulating component (such as a liquid crystal box) is in the display area for displaying images. The non-display area is opaque and covers structures such as metal wiring electrically connected to other components. The circuit board usually extends to the surface of the array substrate and is electrically connected to the metal wiring on the array substrate in the non-display area. The driving chip is in the non-display area and is electrically connected to the metal wiring on the array substrate. The modes of connection between the array substrate, the light-modulating module, the circuit board, and the driving chip are not conducive to reducing size of the non-display area of the array substrate.

### BRIEF DESCRIPTION OF DRAWINGS

FIG. 1 is a planar view of a display device in an embodiment of the present disclosure.

FIG. 2 is a cross-sectional view along line A-A of FIG. 1.

FIG. 3 is a cross-sectional view of a display device in another embodiment of the present disclosure.

FIG. 4 is a cross-sectional view of a display device in another embodiment of the present disclosure.

FIG. 5 shows a metallographic structure of a through hole with an aspect ratio of 5.

FIG. 6 shows a metallographic structure of a through hole with an aspect ratio of 12.

FIG. 7 is a cross-sectional view of a display device in another embodiment of the present disclosure.

FIG. 8 is a cross-sectional view of a display device in another embodiment of the present disclosure.

FIG. 9 is a cross-sectional view of a display device in another embodiment of the present disclosure.

FIG. 10 is a cross-sectional view of a display device in another embodiment of the present disclosure.

FIG. 11 is a cross-sectional view of a display device in a first comparative embodiment.

FIG. 12 is a cross-sectional view of a display device in a second comparative embodiment.

### DETAILED DESCRIPTION

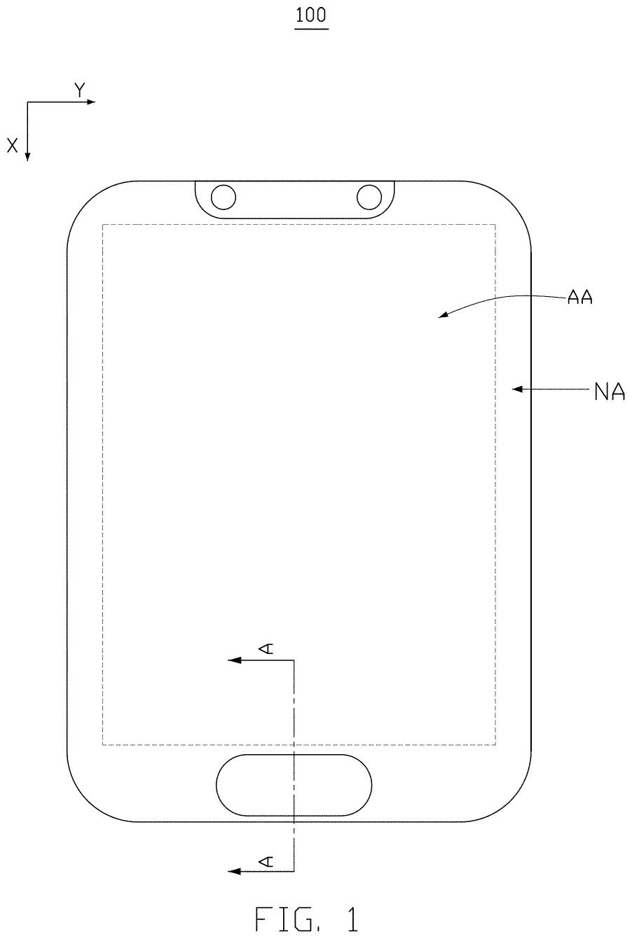

As shown in FIG. 1, a smart phone is an exemplary embodiment of display device 100. In other embodiments, the display device 100 may be a television, a computer, or the like. In this embodiment, the display device 100 is a liquid crystal display device. In other embodiments, the display device 100 may be an organic light-emitting display device, a micro light-emitting diode display device, or the like.

The display device 100 includes a display area AA and a non-display area NA connected to each other, wherein the non-display area NA surrounds the display area AA. The display area AA is used to emit image light to display images. The non-display area NA is opaque and covers structures such as wiring, chips, and other components.

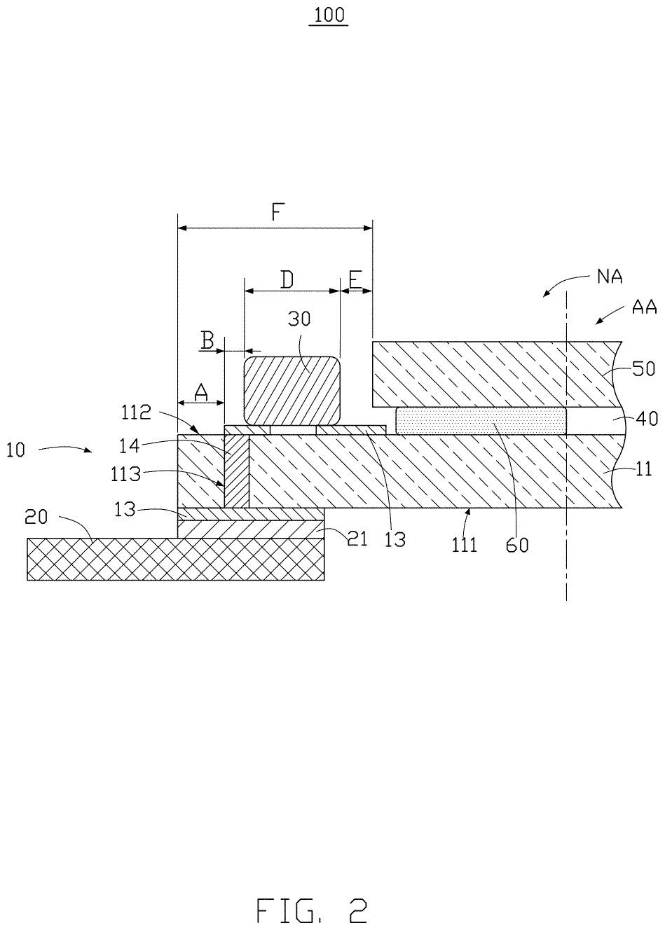

As shown in FIG. 2, in this embodiment, the display device 100 includes a thin film transistor array substrate 10, a circuit board 20, a driving chip 30, a light modulating layer 40, a color filter substrate 50, and a sealing frame glue 60.

The thin film transistor array substrate 10 includes a glass substrate 11 facing the color filter substrate 50. The light modulating layer 40 is between the glass substrate 11 and the color filter substrate 50. The glass substrate 11 and the color filter substrate 50 are partially in the display area AA and partially in the non-display area NA. The light modulating layer 40 is entirely in the display area AA and is between the glass substrate 11 and the color filter substrate 50. The glass substrate 11 includes a first surface 111 and a second surface 112 opposite to each other. The circuit board 20 is in the non-display area NA and is on the first surface 111 of the glass substrate 11. The driving chip 30 is in the non-display area NA and is on the second surface 112 of the glass substrate 11. The sealing frame glue 60 is on the second surface 112 of the glass substrate 11 and is between the glass substrate 11 and the color filter substrate 50. The sealing frame glue 60, the glass substrate 11, and the color filter substrate 50 cooperatively form a receiving space, the light modulating layer 40 is in the receiving space.

The circuit board 20 and the driving chip 30 output drive signals to the light modulating layer 40. The light modulating layer 40 modulates source light directed through it according to the driving signals. The color filter substrate 50 filters the light from the light modulating layer 40 to emit light forming images.

In this embodiment, the light modulating layer 40 includes a liquid crystal layer (light modulating layer 40 further includes conventional structures such as electrodes). In other embodiments, when the display device 100 is an organic light-emitting display device, the light modulating layer 40 is an organic light-emitting material layer, and the display device 100 does not include a color filter substrate 50. When the display device 100 is a micro-LED display device, the light modulating layer 40 includes a plurality of micro-LEDs arranged in an array, and the display device 100 does not include a color filter substrate 50. In this embodiment, the thin film transistor array substrate 10 also includes a driving circuit 13 on both the first surface 111 and the second surface 112 of the glass substrate 11.

In this embodiment, a through hole 113 is defined on a part of the glass substrate 11 in the non-display area NA. The thin film transistor array substrate 10 also includes a conductive part 14 in the through hole 113. The through hole 113 extends through both the first surface 111 and the second surface 112 of the glass substrate 11. The conductive part 14 in the through hole 113 extends from the through hole 113 to the first surface 111 and the second surface 112 of the glass substrate 11, and is electrically connected to the driving circuit 13 on the first surface 111 and the second surface 112. That is, an electrical connection is established between the driving circuit 13 on the first surface 111 and the second surface 112 of the glass substrate 11 by the conductive part 14. In this embodiment, the conductive part 14 and the driving circuit 13 use the same conductive material, such as copper metal. In this embodiment, the circuit board 20 is electrically connected to the driving circuit 13 on the first surface 111 of the glass substrate 11, and the driving chip 30 is electrically connected to the driving circuit 13 on the second surface 112 of the glass substrate 11. The circuit board 20 includes a metal connection pad 21. The circuit board 20 is in electrical contact with the driving circuit 13 on the first surface 111 of the glass substrate 11 through the connection pad 21.

In this embodiment, the driving circuit 13 on the second surface 112 of the glass substrate 11 is in the non-display area NA and the display area AA (not shown). A portion of the driving circuit 13 in the display area AA is electrically connected to the light modulating layer 40. Therefore, in this embodiment, an electrical connection is established between the circuit board 20, the driving chip 30, and the light modulating layer 40 by the through hole 113 and the conductive part 14, and electrical signals can be transmitted. That is, in this embodiment, an electrical connection is established between conductive structures on different sides of the thin film transistor array substrate 10 through the through hole 113 and the conductive part 14, and the electrical signals can be transmitted therethrough.

In other embodiments, other numbers of through holes 113 may be provided on the glass substrate 11, and the thin film transistor array substrate 10 may include other conductive parts 14. The number of the through holes 113 is the same as that of the conductive part 14. That is, the through hole(s) 113 has/have a one-to-one correspondence with the conductive part(s) 14. That is, each and every through hole 113 accommodates one conductive part 14. The number of the through holes 113 and the number of the conductive parts 14 are determined according to electrical connections mode of the thin film transistor array substrate 10, the circuit board 20, the driving chip 30, the light modulating layer 40, and the color filter substrate 50.

As shown in FIG. 2, in this embodiment, the conductive part 14 is a pillar embedded in the through hole 113 and completely filling the through hole 113.

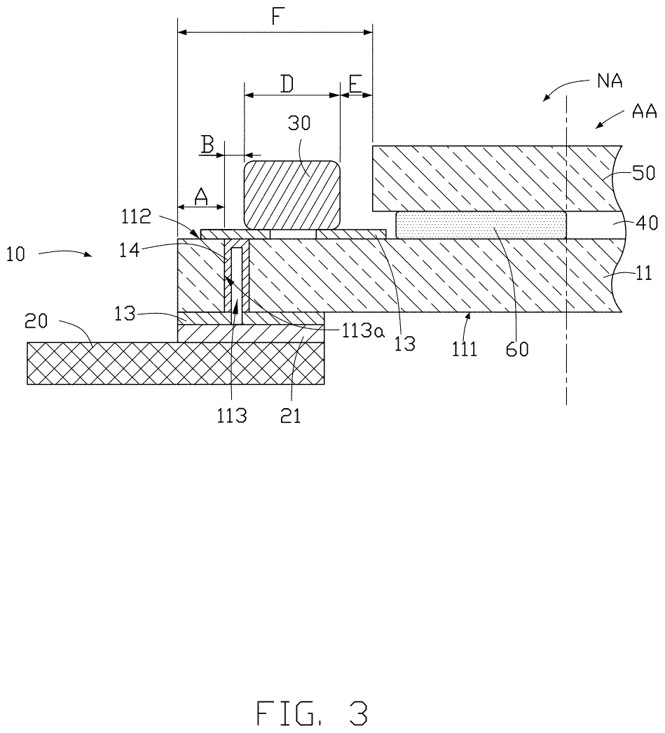

As shown in FIG. 3, in another embodiment of the present disclosure, the conductive part 14 is attached to an inner wall 113a of the through hole 113 and extends to the first surface 111 and the second surface 112 of the glass substrate 11 to connect with the driving circuit 13 on the first surface 111 and the second surface 112. That is, the through hole 113 is not completely filled by the conductive part 14, only the inner wall 113a is covered by the conductive part 14.

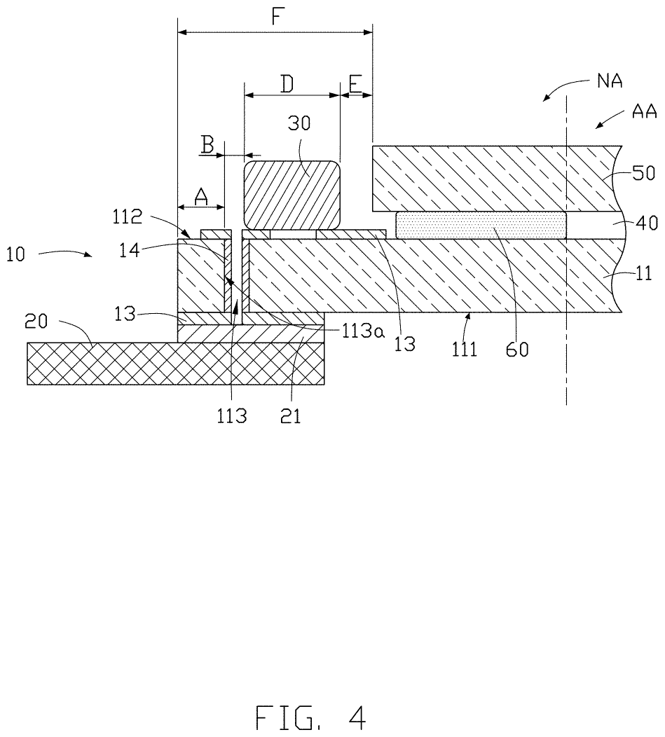

As shown in FIG. 4, in another embodiment of the present disclosure, the through hole 113 extends through both the glass substrate 11 and the driving circuit 13 on the first surface 111 of the glass substrate 11. The conductive part 14 in the through hole 113 is attached to the inner wall 113a of the through hole 113 and extends to the first surface 111 and the second surface 112 of the substrate 11 to connect with the driving circuit 13 on the first surface 111 and the second surface 112.

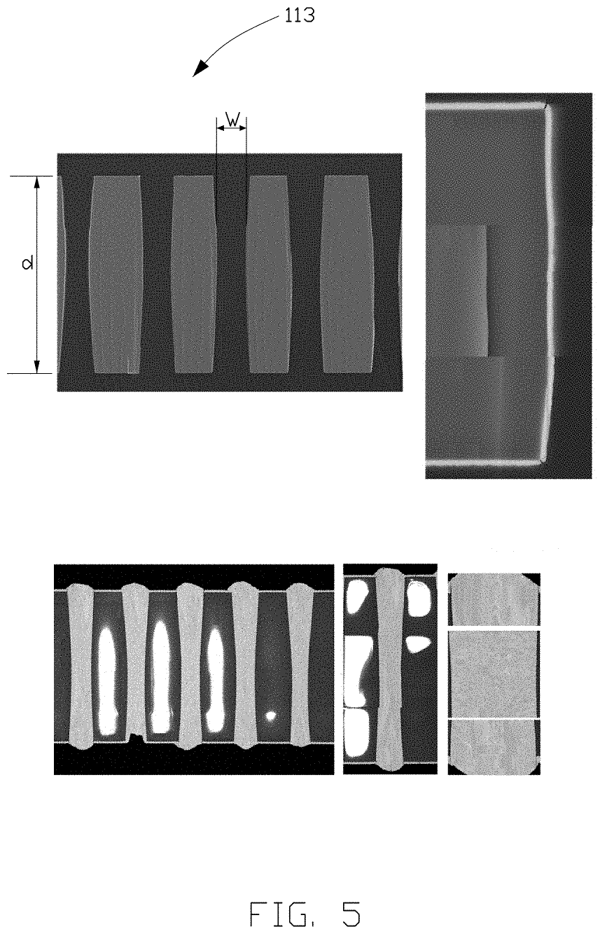

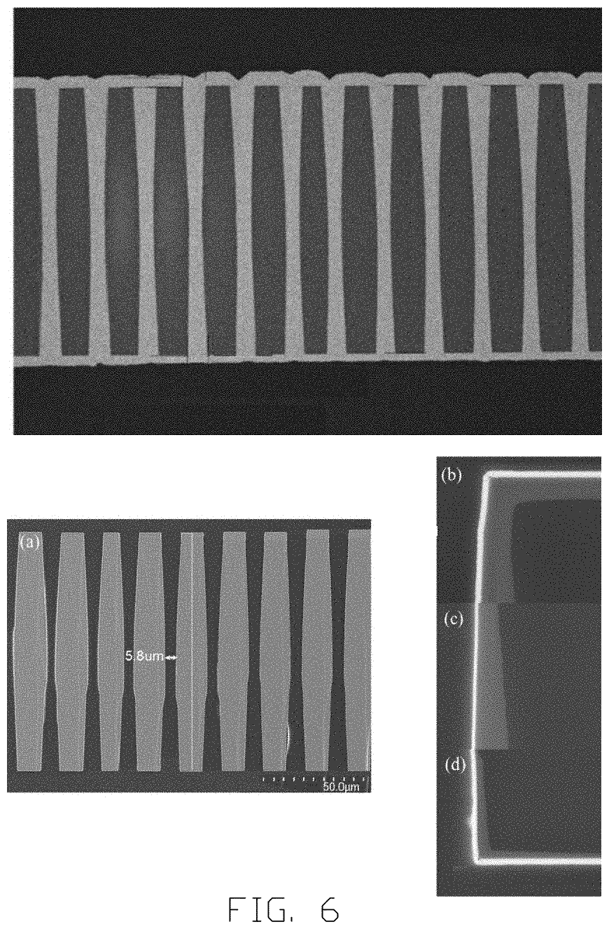

As shown in FIG. 5, in this embodiment, the through hole 113 is roughly circular and is formed by laser etching the glass substrate 11. The through hole 113 has a depth d and a width (that is, diameter) W, wherein an aspect ratio AR of the through hole 113 is defined as a ratio of the depth d to the width W. That is, AR=d/W. FIG. 5 shows a structure of the through hole 113 with an aspect ratio AR=5, while FIG. 6 shows a structure of the through hole 113 with an aspect ratio AR=12.

The aspect ratio AR of the through hole 113 affects a size and a shape of the conductive part 14 in the through hole 113. Conductive parts 14 of different sizes and shapes have different conductivities. The better the conductivity of the conductive part 14 in the through hole 113, the greater the aspect ratio AR of the through hole 113. However, the greater the aspect ratio AR of the through hole 113, the higher is the difficulty and the higher is the cost of the etching process of the through hole 113. Therefore, the conductivity of the conductive part 14 in the through hole 113 must be balanced with the processing difficulty of the through hole 113. In this embodiment, the aspect ratio AR of the through hole 113 is between 8-12.

In this embodiment, since the circuit board 20 and the driving chip 30 are on different surfaces of the thin film transistor array substrate 10, the circuit board 20 and the driving chip 30 occupy space in a thickness direction of the thin film transistor array substrate 10. Compared with the circuit board 20 and the driving chip 30 being on a same surface of the thin film transistor array substrate 10, this embodiment reduces size of the non-display area NA of the thin film transistor array substrate 10 in a length direction (direction X in FIG. 1) and in a width direction (direction Y in FIG. 1). A frame area of the display device 100 is defined as area from an edge of the color filter substrate 50 to an edge of the thin film transistor array substrate 10, wherein the frame area has a width F in the width direction. In this embodiment, an electrical connection is established between conductive structures on different sides of the thin film transistor array substrate 10 through the through hole 113 and the conductive part 14, which reduces size of the frame area of the display device 100 and reduces an overall length and width of the display device 100.

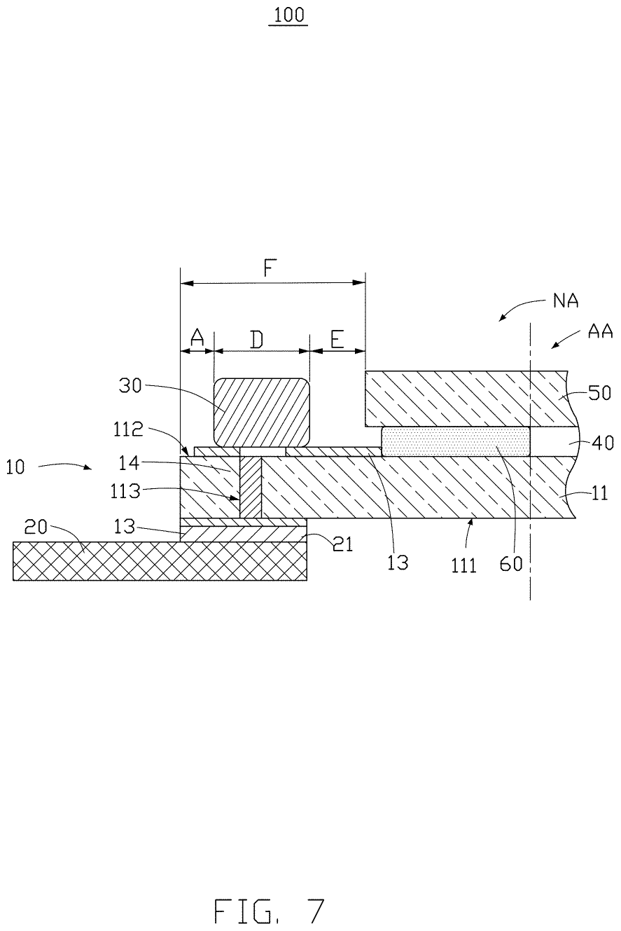

As shown in FIG. 7, in another embodiment, the conductive part 14 in the through hole 113 is directly electrically connected to the driving chip. That is, orthographic projections of the through hole 113, the conductive part 14, and the driving chip 30 on the glass substrate 11 at least partially overlap with each other. In this embodiment, the through hole 113 multiplexes space occupied by the driving chip 30 in the width direction, which further reduces the size of the frame area of the display device 100.

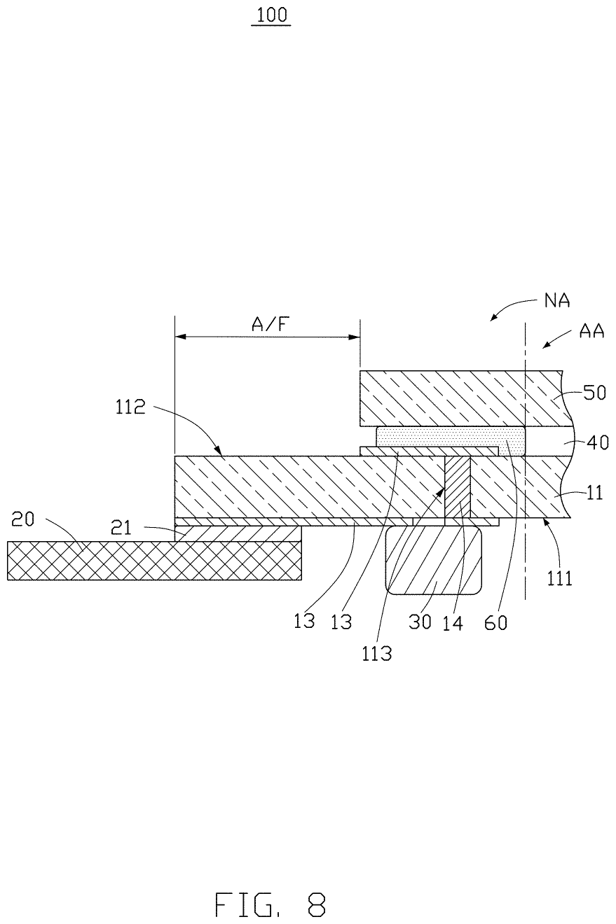

As shown in FIG. 8, in another embodiment, the driving chip 30 is also on the first surface 111 of the glass substrate 11. The circuit board 20 and the driving chip 30 are electrically connected to the driving circuit 13 on the first surface 111. The conductive part 14 in the through hole 113 is electrically connected to the driving circuit 13 on the first surface 111 and the second surface 112 of the glass substrate 11. The orthographic projections of the driving chip 30 and the sealing frame glue 60 on the glass substrate 11 at least partially overlap. Therefore, in this embodiment, the driving chip 30 reuses space occupied by the sealing frame glue 60 in the X direction, which further reduces the size of the frame area of the display device 100.

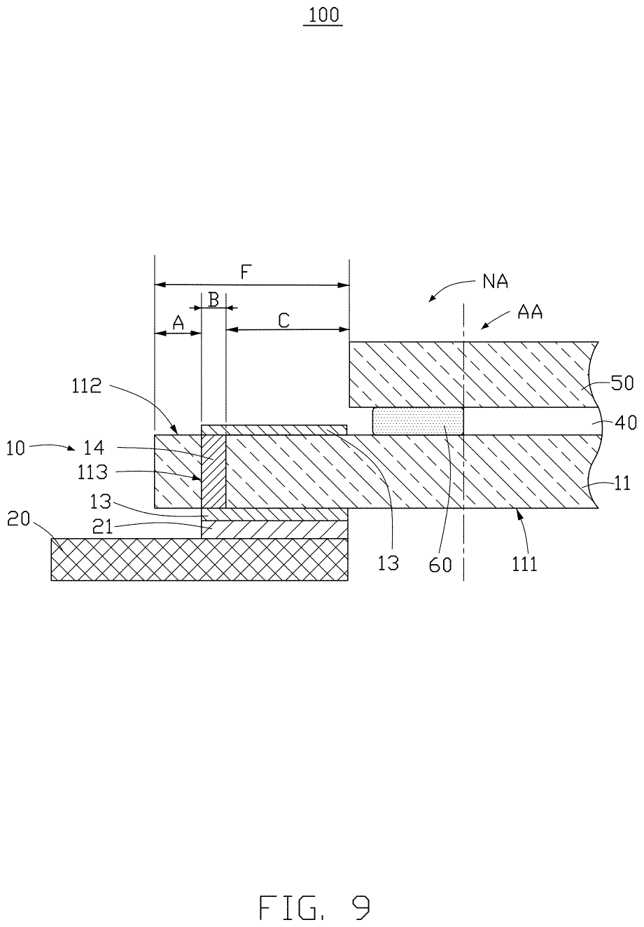

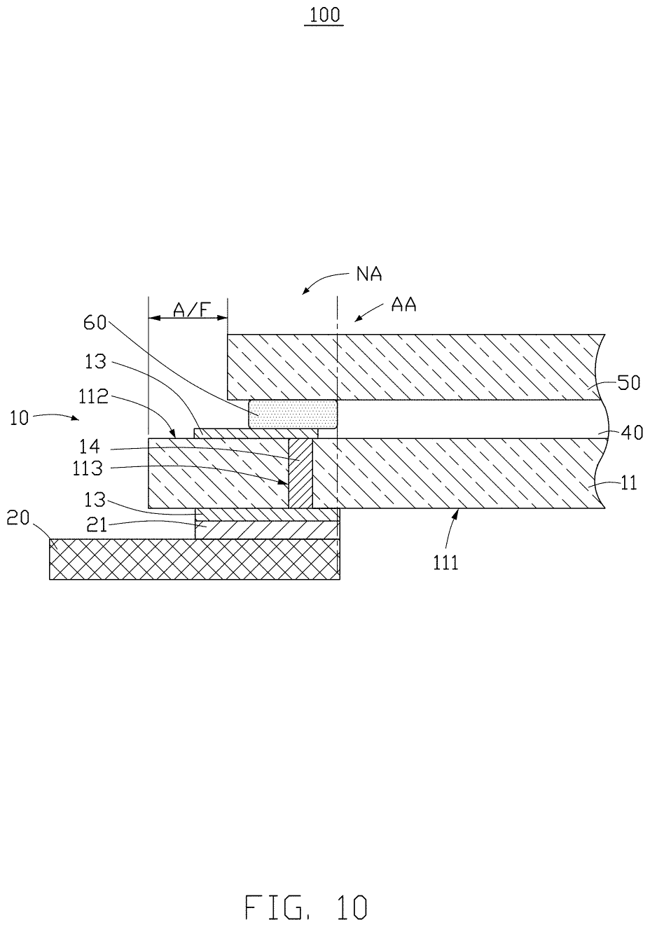

As shown in FIG. 9 and FIG. 10, in another embodiment, the driving chip is integrated into the circuit board 20 (FIG. 9 and FIG. 10 do not show the driving chip in the circuit board 20), which further reduces the size of the frame area of the display device 100.

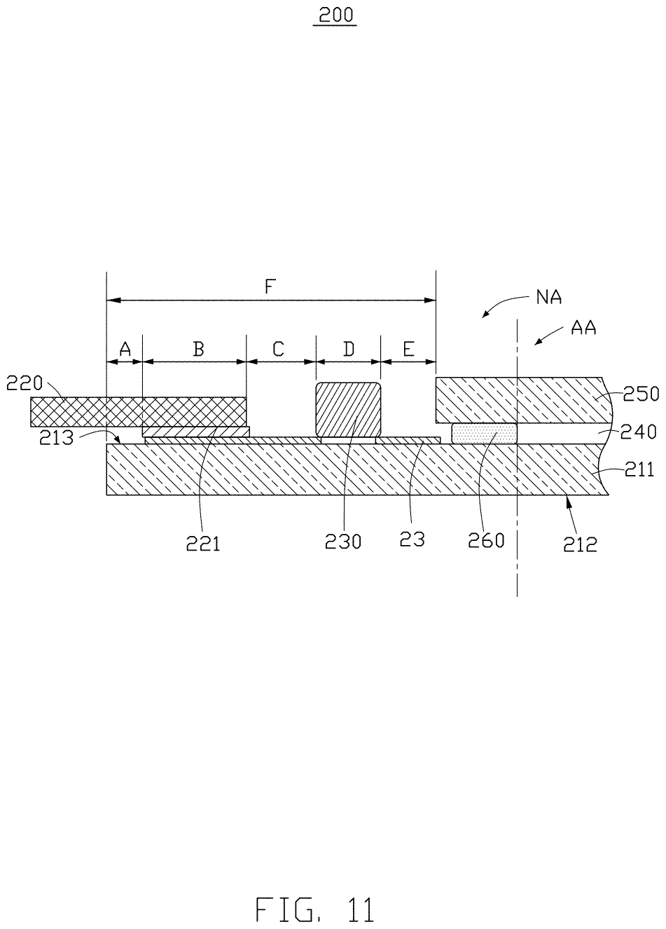

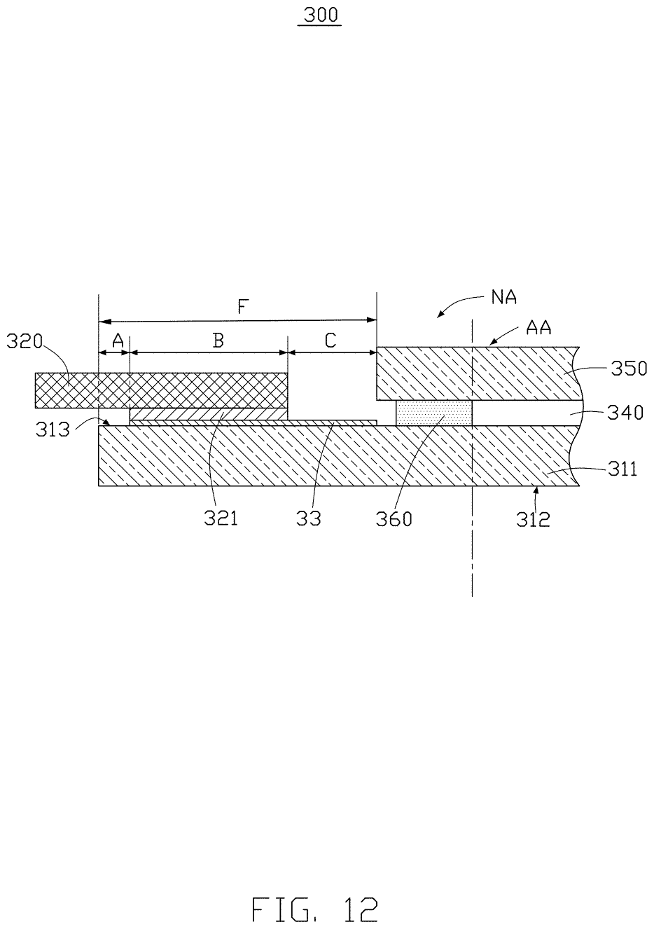

FIG. 11 and FIG. 12 show structures of display device sectionally in two comparative embodiments. Sizes of structures of the display device 100 in the present disclosure and the display devices in the comparative embodiments are shown in Table 1 below.

TABLE 1

| | | A | B | C | D | E | F | Reduction |
|---|---|---|---|---|---|---|---|---|
| | | (μm) | (μm) | (μm) | (μm) | (μm) | (μm) | ratio |
| comparative embodiment 1 (FIG. 11) | | 0.1 | 0.4 | 0.3 | 1.0 | 0.3 | 2.1 | — |
| COG (chip | FIGS. 2-4 | 0.1 | 0.1 | 0 | 1.0 | 0.3 | 1.5 | 28.6% |
| on glass) | FIG. 7 | 0.1 | 0 | 0 | 0.8 | 0.3 | 1.2 | 38.0% |
| | FIG. 8 | 0.1 | 0 | 0 | 0 | 0 | 0.1 | 92.2% |
| comparative embodiment 2 (FIG. 12) | | 0.1 | 0.4 | 0.3 | — | — | 0.8 | — |
| COF (chip | FIG. 9 | 0.1 | 0.1 | 0.3 | — | — | 0.5 | 37.5% |
| on Film) | FIG. 10 | 0.1 | 0 | 0 | — | — | 0.1 | 80.0% |

As can be seen from the Table 1 above, the display device 100 (shown in FIGS. 2-4 and 7-10) provided in the present disclosure reduces the width F of the frame area, which reduces the size of the non-display area NA. For the display device 100 shown in FIG. 10, the width F of the frame area is reduced by 80% compared to that of the comparative embodiment 2.

Technicians in the field will realize that the above embodiments are only used to illustrate the present disclosure and not to limit the present disclosure. Appropriate changes made to the above embodiments fall within a protection scope of the present disclosure as long as the changes are within a substantive spirit of the present disclosure.

What is claimed is:

1. A display device defining a display area and a non-display area connected to each other, the display device comprising:
a thin film transistor array substrate comprising:
a glass substrate comprising a first surface and a second surface opposite to each other, the glass substrate defining at least one through hole extending through the first surface and the second surface, the at least one through hole being in the non-display area;
a driving circuit on both the first surface and the second surface; and
at least one conductive part corresponding to the at least one through hole one to one, each of the at least one conductive part being in one of the at least one through hole and extending to electrically connect to the driving circuit on the first surface and the second surface;
a circuit board in the non-display area and electrically connected to the driving circuit on the first surface; and
a light modulating layer in the display area and on the second surface, the light modulating layer being electrically connected to the driving circuit on the second surface, the circuit board and the driving circuit being configured to drive the light modulating layer to display images.

2. The display device of claim 1 further comprising a driving chip on the circuit board, wherein the driving chip is electrically connected to the circuit board.

3. The display device of claim 1 further comprising a driving chip on the first surface, wherein the driving chip is electrically connected to the driving circuit on the first surface.

4. The display device of claim 3, wherein an orthographic projection of the at least one through hole on the glass substrate at least partially overlap with an orthographic projection of the driving chip on the glass substrate.

5. The display device of claim 3, wherein the light modulating layer comprises a liquid crystal layer;
the display device further comprises:
a color filter substrate; and
a sealing frame glue between the glass substrate and the color filter substrate, wherein the sealing frame glue, the glass substrate, and the color filter substrate form a receiving space configured for receiving the liquid crystal layer, and the color filter substrate filters light modulated by the liquid crystal layer.

6. The display device of claim 5, wherein an orthographic projection of the sealing frame glue on the glass substrate at least partially overlaps with an orthographic projection of the driving chip on the glass substrate.

7. The display device of claim 1, further comprising a driving chip on the second surface, wherein the driving chip is electrically connected to the driving circuit on the second surface.

8. The display device of claim 7, wherein an orthographic projection of the at least one through hole on the glass substrate does not overlap with an orthographic projection of the driving chip on the glass substrate.

9. The display device of claim 7, wherein the at least one conductive part is electrically connected to the driving chip; and
an orthographic projection of the at least one through hole on the glass substrate at least partially overlaps with an orthographic projection of the driving chip on the glass substrate.

10. The display device of claim 1, wherein each of the at least one through hole extends through the driving circuit on the first surface.

11. The display device of claim 1, wherein each of the at least one conductive part is a pillar and is embedded in a corresponding one of the at least one through hole.

12. The display device of claim 1, wherein each of the at least one conductive part covers an inner wall of one of the at least one through hole.

13. A thin film transistor array substrate comprising:
a glass substrate comprising a first surface and a second surface opposite to each other, the glass substrate defining at least one through hole extending through the first surface and the second surface;
a driving circuit on the first surface and the second surface; and
at least one conductive part corresponding to the at least one through hole one to one, each of the at least one conductive part being in one of the at least one through hole and extending to electrically connect to the driving circuit on the first surface and the second surface.
